(19) United States
(12) Patent Application Publication
(10) Pub. No.: US 2024/0150570 A1
(43) Pub. Date: May 9, 2024

(54) THERMOPLASTIC ELASTOMER COMPOSITION AND MOLDED ARTICLE THEREOF

(71) Applicant: MCPP Innovation LLC, Tokyo (JP)

(72) Inventor: Youko Ozama, Tokyo (JP)

(73) Assignee: MCPP Innovation LLC, Tokyo (JP)

(21) Appl. No.: 18/397,974

(22) Filed: Dec. 27, 2023

Related U.S. Application Data
(63) Continuation of application No. PCT/JP2022/022856, filed on Jun. 6, 2022.

(30) Foreign Application Priority Data
Jun. 30, 2021 (JP) 2021-108343

(51) Int. Cl. C08L 53/02; C08G 8/10; C08K 3/16; C08L 23/12; C08L 23/16; C08L 91/00

(52) U.S. Cl. CPC C08L 53/025; C08G 8/10; C08K 3/16; C08L 23/12; C08L 23/16; C08L 91/00; C08L 2203/30; C08L 2205/02; C08L 2205/03; C08L 2207/04

(57) ABSTRACT

A thermoplastic elastomer composition containing a P-Q type diblock copolymer and/or a hydrogenated product thereof in an amount of 0.05 to 2.0 mass % based on a total of 100 mass % of Components (A) to (E), and a molded article thereof: Component (A): a polyolefin, Component (B): an ethylene-α-olefin-non-conjugated diene copolymer rubber, Component (C): a block copolymer and/or a hydrogenated product thereof including a polymer block P mainly containing an aromatic vinyl compound unit and a polymer block Q mainly containing a conjugated diene unit and including a P-Q type diblock copolymer containing one polymer block P and one polymer block Q, Component (D): a hydrocarbon softener for rubber, and Component (E): a crosslinking agent containing a phenol resin.

### CROSS-REFERENCE TO RELATED APPLICATIONS

This application is a continuation of International Application No. PCT/JP2022/022856, filed on Jun. 6, 2022, and claims the benefit of priority to Japanese Application No. 2021-108343, filed on Jun. 30, 2021. The content of each of these applications is hereby incorporated by reference in its entirety.

### TECHNICAL FIELD

The present invention relates to a thermoplastic elastomer composition having excellent surface smoothness and high-temperature rubber elasticity, and a molded article thereof.

### BACKGROUND ART

A thermoplastic elastomer is a material which has fluidity when softened by heating and which has rubber elasticity when cooled. Specifically, the thermoplastic elastomer melts at a processing temperature during molding and can be easily molded in the same way as well-known thermoplastic resins, but has physical properties similar to those of a crosslinked rubber at a temperature at which it is actually used as various materials after molding. In this way, the thermoplastic elastomer has molding processability which is the same as that of thermoplastic resins, has flexibility and unique rubber elasticity, and are recyclable, and is thus widely used in applications such as automobile parts, architectural parts, medical parts, electric wire covering materials, miscellaneous goods, and the like.

Many of members which take advantage of such rubber-like properties are used by applying an external force in a tensile direction, a compressive direction, or the like. It is particularly important to have rubber elasticity in a wide range of operating temperatures, from low-temperature conditions such as in cold regions to high-temperature conditions such as in an engine room of an automobile, and many studies have been disclosed so far.

Patent Literature 1 discloses an automotive weather stripping using a thermoplastic elastomer composition containing an olefin resin, an ethylene-α-olefin copolymer rubber, and a hydrogenated aromatic vinyl-conjugated diene compound block copolymer.

In addition, Patent Literature 2 discloses a thermoplastic elastomer composition having an excellent molded appearance and an excellent compression set at a high temperature, which contains a vinyl aromatic copolymer rubber, an ethylene copolymer rubber, and an olefin resin.

### CITATION LIST

### Patent Literature

Patent Literature 1: JPH10-324200A
Patent Literature 2: JP2011-184594A

### SUMMARY OF INVENTION

### Technical Problem

The thermoplastic elastomer and a molded article thereof are used in parts which are visible to the public, such as an application of an automobile window frame seal. In such an application, not only rubber elasticity but also high designability of the molded article is required, and a smooth surface appearance is required. In addition, in the process of assembling parts, different members are often joined using a double-sided tape or an adhesive, and in order to increase a degree of adhesion with the double-sided tape or the adhesive, a surface of the molded article is required to be smooth. That is, there is a demand for a thermoplastic elastomer and a molded article thereof which have a smooth surface with maintaining rubber elasticity at a high temperature.

There is no description of surface smoothness or high-temperature rubber elasticity for the thermoplastic elastomer composition and an automotive weather stripping molded article disclosed in Patent Literature 1, and there is no specific description of surface smoothness for the thermoplastic elastomer composition disclosed in Patent Literature 2, although extrusion moldability has been confirmed. There is room for improvement in both cases.

It is known to increase a proportion of the olefin resin as a means of improving the surface smoothness of the thermoplastic elastomer composition and the molded article thereof. However, increasing the proportion of the olefin resin causes a decrease in rubber elasticity, which is a trade-off.

The present invention has been made in view of such problems in the related art, and an object thereof is to provide a thermoplastic elastomer composition having excellent surface smoothness and high-temperature rubber elasticity, and a molded article thereof.

### Solution to Problem

As a result of investigations by the inventors to solve the above problems, the present inventor has found that the above problems can be solved by a thermoplastic elastomer composition containing: Component (A): a polyolefin; Component (B): an ethylene-α-olefin-non-conjugated diene copolymer rubber; Component (C): a block copolymer and/or a hydrogenated product thereof including a polymer block P mainly containing an aromatic vinyl compound unit and a polymer block Q mainly containing a conjugated diene unit and including a P-Q type diblock copolymer containing one polymer block P and one polymer block Q; Component (D): a hydrocarbon softener for rubber; and Component (E): a crosslinking agent containing a phenol resin, in which the P-Q type diblock copolymer and/or a hydrogenated product thereof are contained in an amount of 0.05 to 2.0 mass % based on a total of 100 mass % of Components (A) to (E).

That is, the gist of the present invention is as follows.
[1] A thermoplastic elastomer composition containing Components (A) to (E), in which a P-Q type diblock copolymer and/or a hydrogenated product thereof is contained in an amount of 0.05 to 2.0 mass % based on a total of 100 mass % of Components (A) to (E):
Component (A): a polyolefin;
Component (B): an ethylene-α-olefin-non-conjugated diene copolymer rubber;
Component (C): a block copolymer and/or a hydrogenated product thereof including a polymer block P mainly containing an aromatic vinyl compound unit and a polymer block Q mainly containing a conjugated diene unit and including the P-Q type diblock copolymer containing one polymer block P and one polymer block Q;
Component (D): a hydrocarbon softener for rubber; and
Component (E): a crosslinking agent containing a phenol resin.
[2] The thermoplastic elastomer composition according to [1], containing Component (D) in an amount of 50 parts by mass or more and 300 parts by mass or less based on a total of 100 parts by mass of Component (A) and Component (B).
[3] The thermoplastic elastomer composition according to [1] or [2], in which durometer hardness A in JIS K6253 (2006 edition) is 95 or less.
[4] The thermoplastic elastomer composition according to [3], in which the durometer hardness A in JIS K6253 (2006 edition) is 90 or less.
[5] The thermoplastic elastomer composition according to [1] or [2], in which durometer hardness A in JIS K6253 (2006 edition) is 45 or more and 95 or less.
[6] The thermoplastic elastomer composition according to [5], in which the durometer hardness A in JIS K6253 (2006 edition) is 45 or more and 85 or less.
[7] The thermoplastic elastomer composition according to any one of [1] to [6], in which Component (C) is the block copolymer and/or the hydrogenated product thereof containing 1 mass % or more and 100 mass % or less of the P-Q type diblock copolymer.
[8] The thermoplastic elastomer composition according to any one of [1] to [7], in which a content of Component (A) is 1 mass % or more and less than 50 mass % based on a total of 100 mass % of Component (A) and Component (B).
[9] The thermoplastic elastomer composition according to any one of [1] to [8], comprising Component (C) in an amount of 0.1 parts by mass or more and 400 parts by mass or less based on a total of 100 parts by mass of Component (A) and Component (B).
[10] The thermoplastic elastomer composition according to any one of [1] to [9], in which Component (E) contains a phenol resin and a tin chloride.
[11] The thermoplastic elastomer composition according to any one of [1] to [10], in which a weight average molecular weight of Component (A) measured by gel permeation chromatography calibrated with polystyrene standards is 270,000 or more and 1,000,000 or less.
[12] A molded article obtained by molding the thermoplastic elastomer composition according to any one of [1] to [11].

### Effects of Invention

The thermoplastic elastomer composition according to the present invention has excellent surface smoothness and high-temperature rubber elasticity. Therefore, the thermoplastic elastomer composition according to the present invention is expected to be suitably used for automobile parts, architectural parts, medical parts, electric wire covering materials, miscellaneous goods, and the like, specifically, automobile seals which require a good appearance, and various sealing materials, boots, packing, and gaskets which require sealability.

### DESCRIPTION OF EMBODIMENTS

Hereinafter, embodiments of the present invention will be described in detail, but the following explanations are representative examples of embodiments of the present invention, and the present invention is not limited to these contents. Note that in the present invention, “to” is used to include the numerical values described before and after it as a lower limit value and an upper limit value.

[Thermoplastic Elastomer Composition]

In one embodiment, a thermoplastic elastomer composition according to the present invention is a thermoplastic elastomer composition containing a P-Q type diblock copolymer and/or a hydrogenated product thereof in an amount of 0.05 to 2.0 mass % based on a total of 100 mass % of the following Components (A) to (E).
Component (A): a polyolefin;
Component (B): an ethylene-α-olefin-non-conjugated diene copolymer rubber;
Component (C): a block copolymer and/or a hydrogenated product thereof including a polymer block P mainly containing an aromatic vinyl compound unit and a polymer block Q mainly containing a conjugated diene unit and including a P-Q type diblock copolymer containing one polymer block P and one polymer block Q;
Component (D): a hydrocarbon softener for rubber; and
Component (E): a crosslinking agent containing a phenol resin.

In one embodiment, a thermoplastic elastomer composition according to the present invention is a thermoplastic elastomer composition containing the following P-Q type diblock copolymer and/or a hydrogenated product thereof in an amount of 0.05 to 2.0 mass % based on a total of 100 mass % of the following Components (A) to (D).
Component (A): a polyolefin;
Component (B): an ethylene-α-olefin-non-conjugated diene copolymer rubber;
Component (C): a block copolymer and/or a hydrogenated product thereof including a polymer block P mainly containing an aromatic vinyl compound unit and a polymer block Q mainly containing a conjugated diene unit and including a P-Q type diblock copolymer containing one polymer block P and one polymer block Q; and
Component (D): a hydrocarbon softener for rubber.

That is, the thermoplastic elastomer composition according to the present invention is a thermoplastic elastomer composition containing the P-Q type diblock copolymer and/or a hydrogenated product thereof in an amount of 0.05 to 2.0 mass % based on a total of 100 mass % of the above Components (A) to (D), and in the case of further containing a crosslinking agent containing a phenol resin as Component (E), based on a total of 100 mass % of the above Components (A) to (E).

In the following, “a total of 100 mass % of Components (A) to (E)” corresponds to “a total of 100 mass % of Components (A) to (D)” when Component (E) is not contained.

[P-Q Type Diblock Copolymer and/or Hydrogenated Product Thereof]

A content of the P-Q type diblock copolymer and/or a hydrogenated product thereof (hereinafter, may be referred to as a “P-Q type (hydrogenated) diblock copolymer”) based on a total of 100 mass % of Components (A) to (E) in the thermoplastic elastomer composition according to the present invention is 0.05 to 2.0 mass %. When the thermoplastic elastomer composition according to the present invention contains the P-Q type (hydrogenated) diblock copolymer in the above proportion, both surface smoothness and high-temperature rubber elasticity can be achieved.

It is presumed that a mechanism of surface smoothness development is that compared to a P-Q-P type, the P-Q type (hydrogenated) diblock copolymer has higher molecular mobility of the polymer block Q, and therefore easily precipitates on a surface of a molded article and acts to fill in an unevenness of the surface formed by agglomeration of Component (B), smoothing the unevenness of the surface and improving the surface smoothness.

The lower limit of the content of the P-Q type (hydrogenated) diblock copolymer is preferably 0.05 mass % or more, more preferably 0.1 mass % or more, and still more preferably 0.2 mass % or more from the viewpoint of improving the surface smoothness. On the other hand, the upper limit thereof is preferably 2.0 mass % or less, and more preferably 1.8 mass % or less from the viewpoint of maintaining the high-temperature rubber elasticity.

A method of setting the content of the P-Q type (hydrogenated) diblock copolymer based on the total of 100 mass % of Components (A) to (E) in the thermoplastic elastomer composition according to the present invention into the above range is not particularly limited, and it is preferable to select and mix a component containing 1 mass % or more, preferably 10 mass % or more, and more preferably 20 mass % or more of the P-Q type (hydrogenated) diblock copolymer as Component (C), which will be described later. The upper limit of the content of the P-Q type (hydrogenated) diblock copolymer contained in Component (C) is not particularly limited, and it is generally 100 mass % or less, preferably 90 mass % or less, more preferably 80 mass % or less, and still more preferably 50 mass % or less.

[Component (A)]

Examples of the polyolefin as Component (A) include ethylene-based copolymer such as a polypropylene, a polyethylene, poly-1-butene, an ethylene-vinyl acetate copolymer, an ethylene-(meth)acrylic acid copolymer, and an ethylene-(meth)acrylic acid ester copolymer. A polypropylene is preferably used because of having excellent heat resistance, molding processability, etc.

The polypropylene is a polyolefin in which a content of a propylene unit based on all monomer units is more than 50 mass %.

The type of the polypropylene is not particularly limited, and any propylene copolymer such as a propylene homopolymer, a propylene random copolymer, or a propylene block copolymer can be used.

When the polypropylene is a propylene random copolymer, examples of a monomer which copolymerize with propylene include ethylene, 1-butene, 2-methylpropylene, 1-pentene, 3-methyl-1-butene, 1-hexene, 4-methyl-1-pentene, and 1-octene. In addition, when the polypropylene is a propylene block copolymer, examples thereof include a propylene block copolymer obtained by multi-stage polymerization, and specific examples thereof include a propylene block copolymer obtained by polymerizing a polypropylene in the first stage and polymerizing a propylene-ethylene copolymer in the second stage.

A content of the propylene unit in the polypropylene is preferably 60 mass % or more, more preferably 75 mass % or more, and still more preferably 90 mass % or more. When the content of the propylene unit is equal to or greater than the above lower limit value, heat resistance and rigidity tend to be good. On the other hand, the upper limit of the content of the propylene unit in the polypropylene is not particularly limited, and is generally 100 mass %. Note that the content of the propylene unit in the polypropylene can be determined by infrared spectroscopy.

A weight average molecular weight of the polypropylene as Component (A) is preferably 270,000 or more, more preferably 300,000 or more, and still more preferably 320,000 or more as a value measured by gel permeation chromatography (hereinafter sometimes abbreviated as GPC) calibrated with polystyrene standards. On the other hand, the weight average molecular weight is preferably 1,000,000 or less, more preferably 950,000 or less, and still more preferably 900,000 or less, from the viewpoint of the surface smoothness.

The weight average molecular weight of the polypropylene as Component (A) is measured by the GPC method. An example of measurement conditions is shown below.
(1) Apparatus: HLC-8321 GPC/HT manufactured by Tosoh Corporation
(2) Separation column: three TSKgel GMH_{HR}-H (20) HT
(3) Measurement temperature: 140° C.
(4) Carrier: 1,2,4-trichlorobenzene
(5) Flow rate: 1.0 mL/min
(6) Sample concentration: 1 mg/mL
(7) Sample injection amount: 300 μL
(8) Detector: differential refractometer
(9) Molecular weight standard material: standard polystyrene

In addition, a melt flow rate of the polypropylene as Component (A) (measurement temperature: 230° C., measurement load: 21.18 N) is not limited, and is generally 0.1 g/10 min. or more, and preferably 0.5 g/10 min. or more from the viewpoint of the surface smoothness and the moldability. The upper limit is generally 60 g/10 min. or less, and from the viewpoint of rubber elasticity, preferably 50 g/10 min. or less, and more preferably 40 g/10 min. or less.

The melt flow rate of the polypropylene as Component (A) is measured according to JIS K7210 (1999) under a condition of a measurement temperature of 230° C. and a measurement load of 21.18 N.

As a method for producing the polypropylene, a polymerization method using a known catalyst for olefin polymerization is used. For example, a multi-stage polymerization method using a Ziegler-Natta catalyst can be mentioned. As this multi-stage polymerization method, a slurry polymerization method, a solution polymerization method, a bulk polymerization method, a gas phase polymerization method, or the like can be used, and two or more of these methods may be used in combination for production.

In addition, a commercially available polypropylene can also be used. The commercially available polypropylene can be purchased from the manufacturers listed below, and can be selected as appropriate. Examples of commercially available products include Novatec (registered trademark) PP from Japan Polypropylene Corporation, Prime Polypro (registered trademark) from Prime Polymer Co., Ltd., SUMITOMO NOBLEN (registered trademark) from Sumitomo Chemical Co., Ltd., a polypropylene block copolymer from SunAllomer Ltd., Moplen (registered trademark) from LyondellBasell Industries Holdings, ExxonMobil PP from Exxon Mobil Corporation, Formolene (registered trademark) from Formosa Plastics Corporation, Borealis PP from Borealis AG., SEETEC PP from LG Chem., ASI POLYPROPYLENE from A. Schulman, Inc., INEOS PP from INEOS Olefins & Polymers, Braskem PP from Braskem, Sumsung Total from Samsung Total Petrochemicals Co., Ltd., Sabic (registered trademark) PP from Sabic, TOTAL PETROCHEMICALS Polypropylene from TOTAL PETROCHEMICALS, and YUPLENE (registered trademark) from SK Geo Centric.

The thermoplastic elastomer composition according to the present invention may contain only one type of polyolefin such as a polypropylene, or may contain two or more types of monomer units which differ in type, content, physical properties, or the like.

[Component (B)]

The ethylene-α-olefin-non-conjugated diene copolymer rubber as Component (B) is a copolymer containing ethylene, α-olefin, and a non-conjugated diene compound as copolymer components. The ethylene-α-olefin-non-conjugated diene copolymer rubber includes an oil-extended type which is a mixture of an ethylene-α-olefin-non-conjugated diene copolymer rubber and a hydrocarbon softener for rubber (hereinafter, it may also be referred to as an “oil-extended ethylene-α-olefin-non-conjugated diene copolymer rubber”) and a non-oil-extended type which does not contain a hydrocarbon softener for rubber. In the present embodiment, an oil-extended type of copolymer rubber is intended, but a low-oil-extended type or a non-oil-extended type can also be suitably used. That is, in the present invention, as the ethylene-α-olefin-non-conjugated diene copolymer rubber as Component (B), both an oil-extended type and a non-oil-extended type can be used. Only one type of the non-oil-extended type or the oil-extended type may be used alone, or two or more types thereof may be used in any combination and ratio. One or two or more of the oil-extended types and one or two or more of the non-oil-extended types can be used in any combination and ratio.

Note that here, when Component (B) is an oil-extended ethylene-α-olefin-non-conjugated diene copolymer rubber, the hydrocarbon softener for rubber contained in the oil-extended ethylene-α-olefin-non-conjugated diene copolymer rubber is contained in a hydrocarbon softener for rubber as Component (D).

Examples of the α-olefin in Component (B) include but are not particularly limited to α-olefins having from 3 to 20 carbon atoms, and more preferably from 3 to 8 carbon atoms, such as propylene, 1-butene, 3-methyl-1-butene, 1-pentene, 4-methyl-1-pentene, 4,4-dimethyl-1-pentene, 1-hexene, 4-methyl-1-hexene, 1-heptene, 1-octene, 1-decene, and 1-octadecene. Among these, propylene, 1-butene, 3-methyl-1-butene, and 1-pentene are preferred, and propylene and 1-butene are more preferred, from the viewpoint of crosslinking properties and prevention of blooming of the crosslinking agent during dynamic crosslinking. Note that one type of the α-olefin may be used alone, or two or more types thereof may be used in any combination and ratio.

Examples of the non-conjugated diene compound in Component (B) include but are not particularly limited to dicyclopentadiene, 1,4-hexadiene, cyclohexadiene, cyclooctadiene, dicyclooctadiene, 1,6-octadiene, 5-methyl-1,4-hexadiene, 3,7-dimethyl-1,6-octadiene, 1,3-cyclopentadiene, 1,4-cyclohexadiene, 2-methyl-1,5-hexadiene, 6-methyl-1,5-heptadiene, 7-methyl-1,6-octadiene, tetrahydroindene, methyltetrahydroindene, 5-isopropylidene-2-norbornene, 5-vinyl-2-norbomene, vinylidene norbomene, ethylidene norbomene such as 5-ethylidene-2-norbomene (ENB), and methylene norbomene such as 5-methylene-2-norbomene (MNB). Among these, dicyclopentadiene, ethylidene norbomene, and vinylidene norbomene are preferred, and dicyclopentadiene, 5-ethylidene-2-norbomene, and vinylidene norbomene are more preferred, from the viewpoint of crosslinking properties of the crosslinking agent during dynamic crosslinking. Note that one type of the non-conjugated diene compound may be used alone, or two or more types thereof may be used in any combination and ratio.

Specific examples of the ethylene-α-olefin-non-conjugated diene copolymer rubber include but are not particularly limited to an ethylene-propylene-non-conjugated diene copolymer rubber (EPDM) such as an ethylene-propylene-5-ethylidene-2-norbomene copolymer rubber, an ethylene-propylene-dicyclopentadiene copolymer rubber, an ethylene-propylene-1,4-hexadiene copolymer rubber, and an ethylene-propylene-5-vinyl-2-norbomene copolymer rubber, and an ethylene-1-butene-5-ethylidene-2-norbomene copolymer rubber. Among these, an ethylene-propylene-non-conjugated diene copolymer rubber (EPDM) is preferred from the viewpoint of crosslinking properties and prevention of blooming of the crosslinking agent during dynamic crosslinking. Note that one type of the ethylene-α-olefin-non-conjugated diene copolymer rubber may be used alone, or two or more types thereof may be used in any combination and ratio.

A content of an ethylene unit in the ethylene-α-olefin-non-conjugated diene copolymer rubber is not particularly limited, and is preferably from 50 to 90 mass %, more preferably from 55 to 85 mass %, and still more preferably from 60 to 80 mass %. When the content of the ethylene unit is within the above preferred range, a thermoplastic elastomer composition having excellent mechanical strength and rubber elasticity tends to be easily obtained.

In addition, a content of an α-olefin unit in the ethylene-α-olefin-non-conjugated diene copolymer rubber is not particularly limited, and is preferably from 9.5 to 49.5 mass %, more preferably from 14 to 44 mass %, and still more preferably from 18 to 38 mass %. When the content of the α-olefin unit is within the above preferred range, a thermoplastic elastomer composition having excellent mechanical strength, moderate flexibility, and rubber elasticity tends to be easily obtained.

Further a content of a non-conjugated diene unit in the ethylene-α-olefin-non-conjugated diene copolymer rubber is not particularly limited, and is preferably from 0.5 to 30 mass %, more preferably from 1 to 20 mass %, and still more preferably from 2 to 10 mass %. When the content of the non-conjugated diene unit is within the above preferred range, it is easier to adjust the crosslinking properties and the moldability, and a thermoplastic elastomer composition having excellent mechanical strength and rubber elasticity tends to be easily obtained.

Note that the content of each structural unit in Component (B) can be determined by infrared spectroscopy.

In the present invention, Component (B) is particularly preferably an ethylene-propylene-non-conjugated diene copolymer rubber having a content of the ethylene unit of 55 to 75 mass %, a content of the propylene unit of 15 to 40 mass % and a content of the non-conjugated diene unit, which is at least one selected from the group consisting of dicyclopentadiene, 5-ethylidene-2-norbornene, and vinylidene norbornene, of 1 to 10 mass %.

Note that as a method for producing Component (B), a polymerization method using a known catalyst for olefin polymerization can be applied. For example, it can be produced by a slurry polymerization method, a solution polymerization method, a bulk polymerization method, or a gas phase polymerization method using a complex-based catalyst such as a Ziegler-Natta catalyst, a metallocene-based complex, or a non-metallocene-based complex. From the viewpoint of the surface smoothness, it is preferable to use a Ziegler-Natta catalyst. Compared to complex-based catalysts such as a metallocene-based complex and a non-metallocene-based complex, those produced using a Ziegler-Natta catalyst tend to have better surface smoothness due to relatively low regularity of a primary structure and high molecular mobility of Component (B).

Among the ethylene-α-olefin-non-conjugated diene copolymer rubber as Component (B) for use in the present invention, a non-oil-extended ethylene-α-olefin-non-conjugated diene copolymer rubber, that is, an ethylene-α-olefin-non-conjugated diene copolymer rubber which is not oil-extended, has a Mooney viscosity (ML₁₊₄, 125° C.) of generally 45 or more, and preferably 50 or more. The Mooney viscosity (ML₁₊₄, 125° C.) of the non-oil-extended ethylene-α-olefin-non-conjugated diene copolymer rubber is more preferably from 50 to 400, and still more preferably from 50 to 300.

On the other hand, a Mooney viscosity (ML₁₊₄, 125° C.) of the oil-extended ethylene-α-olefin-non-conjugated diene copolymer rubber is not particularly limited, and is preferably from 30 to 100, and more preferably from 35 to 80. The Mooney viscosity of Component (B) is preferably equal to or greater than the above lower limit value from the viewpoint of a good compression set and a good appearance of the obtained molded article, and is preferably equal to or less than the above upper limit value from the viewpoint of the moldability.

In the present invention, a relationship regarding the Mooney viscosity (ML₁₊₄, 125° C.) between the ethylene-α-olefin-non-conjugated diene copolymer rubber before oil extension and the oil-extended ethylene-α-olefin-non-conjugated diene copolymer rubber as Component (B) is expressed by the following equation as described in JPH01-103639A.

Calculation equation: log(ML₁/ML₂)=0.0066(ΔPHR)
ML₁: Mooney viscosity of the ethylene-α-olefin-non-conjugated diene copolymer rubber before oil extension
ML₂: Mooney viscosity of oil-extended ethylene-α-olefin-non-conjugated diene copolymer rubber
ΔPHR: oil extension amount per 100 parts by mass of ethylene-α-olefin-non-conjugated diene copolymer rubber

In addition, a density of the ethylene-α-olefin-non-conjugated diene copolymer rubber as Component (B) is not particularly limited, and is preferably 0.850 g/cm³ or more, and more preferably 0.855 g/cm³ or more, and is preferably 0.900 g/cm³ or less, and more preferably 0.890 g/cm³ or less. When the density of the ethylene-α-olefin-non-conjugated diene copolymer rubber as Component (B) is within the above preferred numerical range, a thermoplastic elastomer composition having excellent processability, moldability, flexibility, or the like tends to be easily obtained. Note that this density can be measured based on JIS K7112:1999.

As described above, an oil-extended ethylene-α-olefin-non-conjugated diene copolymer rubber can also be used as Component (B). In the oil-extended ethylene-α-olefin-non-conjugated diene copolymer rubber, the hydrocarbon softener for rubber is used for purposes of softening the ethylene-α-olefin-non-conjugated diene copolymer rubber, increasing the flexibility and the elasticity thereof, improving the processability and fluidity of the obtained thermoplastic elastomer composition, and the like.

Examples of the hydrocarbon softener for rubber for use in the oil-extended ethylene-α-olefin-non-conjugated diene copolymer rubber include a mineral oil-based softener for rubber and a synthetic resin-based softener for rubber Among these, a mineral oil-based softener for rubber is preferred from the viewpoint of affinity with other components. The mineral oil-based softener for rubber is generally a mixture of an aromatic hydrocarbon, a naphthene-based hydrocarbon, and a paraffin-based hydrocarbon. A paraffin-based hydrocarbon in which a proportion of carbon to all carbon atoms is 50% or more is called a paraffin-based oil, a naphthene-based hydrocarbon in which a proportion of carbon to all carbon atoms is 30% to 45% is called a naphthene-based oil, and an aromatic hydrocarbon in which a proportion of carbon to all carbon atoms is 35% or more is called an aromatic oil. Among these, the hydrocarbon softener for rubber used for the oil-extended ethylene-α-olefin-non-conjugated diene copolymer rubber as Component (B) is preferably a paraffin-based softener for rubber (paraffin-based oil). Note that one type of the hydrocarbon softener for rubber may be used alone, or two or more types thereof may be used in any combination and ratio.

The paraffin-based oil for use in the oil-extended ethylene-α-olefin-non-conjugated diene copolymer rubber as Component (B) is not particularly limited, and is one having a kinematic viscosity at 40° C. of generally 20 cSt (centistokes) or more, and preferably 50 cSt or more, and of generally 800 cSt or less, and preferably 600 cSt or less. In addition, those having a pour point of generally −40° C. or higher, preferably −30° C. or higher, and 0° C. or lower are suitably used. Further, those having a flash point (COC) of generally 200° C. or higher, and preferably 250° C. or higher, and of generally 400° C. or lower, and preferably 350° C. or lower are suitably used.

A content ratio of the ethylene-α-olefin-non-conjugated diene copolymer rubber and the hydrocarbon softener for rubber when the oil-extended ethylene-α-olefin-non-conjugated diene copolymer rubber is used as Component (B) is not particularly limited. A content of the hydrocarbon softener for rubber based on 100 parts by mass of the ethylene-α-olefin-non-conjugated diene copolymer rubber is generally 10 parts by mass or more, and preferably 20 parts by mass or more, and is generally 200 parts by mass or less, preferably 160 parts by mass or less, and more preferably 120 parts by mass or less.

A method (oil extension method) for preparing the oil-extended ethylene-α-olefin-non-conjugated diene copolymer rubber is not particularly limited, and any known method can be used. Examples of the oil extension method include a method of mechanically kneading an ethylene-α-olefin-non-conjugated diene copolymer rubber and a hydrocarbon softener for rubber using a mixing roll or a Banbury mixer and extending the mixture with an oil, a method of adding a predetermined amount of a hydrocarbon softener for rubber to an ethylene-α-olefin-non-conjugated diene copolymer rubber, and then removing the solvent by a method such as steam stripping, and a method of stirring and impregnating a mixture of a crumb-like ethylene-α-olefin-non-conjugated diene copolymer rubber and a hydrocarbon softener for rubber using a Henschel mixer or the like. From the viewpoint of preparing an oil-extended ethylene-α-olefin-non-conjugated diene copolymer rubber having a high molecular weight, preferred is a method of adding a predetermined amount of a hydrocarbon softener for rubber to a polymerization reaction solution or suspension of an ethylene-α-olefin-non-conjugated diene copolymer rubber as Component (B), and then removing the solvent.

Note that as the ethylene-α-olefin-non-conjugated diene copolymer rubber as Component (B), many products of various grades are commercially available from domestic and foreign manufacturers, and any commercially available product can be used. Examples of the commercially available products include JSR EPR manufactured by JSR Corporation, Mitsui EPT manufactured by Mitsui Chemicals, Inc., ESPRENE (registered trademark) manufactured by Sumitomo Chemical Co., Ltd., Keltan (registered trademark) manufactured by ARLANXEO, NORDEL (registered trademark) manufactured by DOW CHEMICAL, and KEP manufactured by KUMHO POLYCHEM.

[Component (C)]

Component (C) is a block copolymer and/or a hydrogenated product thereof (hereinafter, may be referred to as a “(hydrogenated) block copolymer”) including a polymer block P mainly containing an aromatic vinyl compound unit (hereinafter, may be simply referred to as a “block P”) and a polymer block Q mainly containing a conjugated diene unit (hereinafter, may be simply referred to as a “block Q”) and including a P-Q type diblock copolymer containing one polymer block P and one polymer block Q.

Here, “mainly containing” means that a content of a monomer unit constituting the block is 50 mol % or more.

A vinyl aromatic compound, i.e., the monomer constituting the block P is not limited, and a styrene derivative such as styrene, α-methylstyrene, and chloromethylstyrene is preferred. Among these, it is more preferable to mainly contain styrene. Note that the block P may contain a monomer other than the vinyl aromatic compound as a raw material.

The monomer constituting block Q is preferably butadiene alone, isoprene alone, or butadiene and isoprene. Note that the block Q may contain a monomer other than butadiene and isoprene as a raw material.

A content of block P in the block copolymer as Component (C) is not limited, and is preferably 5 mass % or more, and more preferably 10 mass % or more. On the other hand, the content is preferably 50 mass % or less, and more preferably 45 mass % or less.

A chemical structure of a copolymer having the block P and the block Q in Component (C) may be linear, branched, radial, etc., and is preferably a block copolymer represented by the following formula (1) or (2).

Component (C) may be a hydrogenated product of the block copolymer having the block P and the block Q. When the copolymer represented by the following formula (1) or (2) is a hydrogenated block copolymer, the thermoplastic resin elastomer composition according to the present invention tends to have good heat aging resistance.

P-(Q-P)ₘ (1)

(P-Q)ₙ (2)

(In the formulae, P represents the block P, Q represents the block Q, m represents an integer of 1 to 5, and n represents an integer of 1 to 5.)

In the formula (1) or (2), m and n are preferably larger in terms of lowering an order-disorder transition temperature of a rubber-like polymer, but are preferably smaller in terms of ease of production and cost.

The thermoplastic elastomer composition according to the present invention contains the P-Q type (hydrogenated) diblock copolymer in an amount of 0.05 to 2.0 mass % based on the total of 100 mass % of Components (A) to (D).

In order to meet this requirement, it is preferable from the viewpoint of the surface smoothness that the (hydrogenated) block copolymer as Component (C) generally contains 1 mass % or more, preferably 10 mass % or more, and more preferably 20 mass % or more of a P-Q type (hydrogenated) diblock copolymer represented by the formula (2) wherein n is 1. The upper limit of the content of the P-Q type (hydrogenated) diblock copolymer in Component (C) is not particularly limited, may be 100 mass %, and, from the viewpoint of good rubber elasticity, is preferably 90 mass % or less, more preferably 80 mass % or less, and still more preferably 50 mass % or less.

Component (C) may be a mixture of the P-Q type (hydrogenated) diblock copolymer and a (hydrogenated) block copolymer represented by the above formula (1) or formula (2) other than the P-Q type (hydrogenated) diblock copolymer. The copolymer other than the P-Q type (hydrogenated) diblock copolymer is preferably a (hydrogenated) block copolymer represented by the formula (1) rather than a (hydrogenated) block copolymer represented by the formula (2), more preferably a (hydrogenated) block copolymer represented by the formula (1) wherein m is 3 or less, and still more preferably a (hydrogenated) block copolymer represented by the formula (1) wherein m is 2 or less, since the rubber elasticity is excellent.

A number average molecular weight of the (hydrogenated) block copolymer as Component (C) is not limited, and is preferably 20,000 or more, and more preferably 40,000 or more as a value measured by gel permeation chromatography (GPC) calibrated with polystyrene standards. In addition, the number average molecular weight is preferably 500,000 or less, and more preferably 400,000 or less. When the number average molecular weight is within the above range, the flexibility and the moldability tend to be good.

A method for producing the block copolymer as Component (C) is not particularly limited and may be any method as long as the above structure and physical properties can be obtained. The block copolymer as Component (C) can be produced, for example, by block polymerization in an inert solvent using a lithium catalyst or the like. In addition, hydrogenation of the block copolymer can be carried out by a known method such as performing hydrogenation in an inert solvent in the presence of a hydrogenation catalyst.

As the (hydrogenated) block copolymer as Component (C), commercially available products can also be used. Examples of the commercially available products include “KRATON” series manufactured by KRATON CORPORATION, “Tuftec (registered trademark)” series manufactured by Asahi Chemical Industry Co., Ltd., “SEPTON (registered trademark)” series manufactured by KURARAY CO., LTD., “TAIPOL” series manufactured by Taiwan Synthetic Rubber Co., Ltd., and “Globalprene” series manufactured by LCY CHEMICAL CORP., and applicable ones can be selected and used as appropriate.

Only one type of Component (C) may be used alone, or two or more types thereof that differ in copolymer component composition, physical properties, or the like may be used in admixture.

[Component (D)]

The thermoplastic elastomer composition according to the present invention preferably contains a hydrocarbon softener for rubber as Component (D) from the viewpoint of increasing the flexibility and the elasticity and improving the processability and the fluidity. Note that Component (D) contains the hydrocarbon softener for rubber contained in the oil-extended ethylene-α-olefin-non-conjugated diene copolymer rubber used as the above Component (B), but even when using the oil-extended ethylene-α-olefin-non-conjugated diene copolymer rubber as Component (B), it is preferable to separately add a hydrocarbon softener for rubber as Component (D) which is different from that in this oil-extended ethylene-α-olefin-non-conjugated diene copolymer rubber. In this case, as the separately added hydrocarbon softener for rubber, any of the same, similar, or different types of hydrocarbon softeners for rubber as the hydrocarbon softener for rubber in the oil-extended ethylene-α-olefin-non-conjugated diene copolymer rubber as Component (B) can be used. The same applies to a case where the crosslinking agent as Component (E) contains a hydrocarbon softener for rubber.

As the hydrocarbon softener for rubber separately added in addition to Component (B), those same as the hydrocarbon softener for rubber for use in the above oil-extended ethylene-α-olefin-non-conjugated diene copolymer rubber can be used. Among these, a paraffin-based softener for rubber (paraffin-based oil) is preferred. One type of the hydrocarbon softener for rubber may be used alone, or two or more types thereof may be used in any combination and ratio.

The paraffin-based oil separately added in addition to Component (B) is not particularly limited, and is one having a kinematic viscosity at 40° C. of generally 10 cSt (centistokes) or more, and preferably 20 cSt or more, and of generally 800 cSt or less, and preferably 600 cSt or less. In addition, those having a pour point of generally −40° C. or higher, preferably −30° C. or higher, and 0° C. or lower are suitably used. In addition, those having a pour point of generally −40° C. or higher, preferably −30° C. or higher, and 0° C. or lower are suitably used. Further, those having a flash point (COC) of generally 200° C. or higher, and preferably 210° C. or higher, and of generally 400° C. or lower, and preferably 350° C. or lower are suitably used.

Note that in a case where the oil-extended ethylene-α-olefin-non-conjugated diene copolymer rubber is used as Component (B), when a hydrocarbon softener for rubber is separately added as Component (D), a content of the hydrocarbon softener for rubber as Component (D) is independent from the content of the hydrocarbon softener for rubber in the oil-extended ethylene-α-olefin-non-conjugated diene copolymer rubber, and can be freely adjusted.

As the hydrocarbon softener for rubber as Component (D), commercially available products may be used. Examples of the commercially available products of Component (D) include “Nisseki Polybutene (registered trademark) HV” series manufactured by JX Nippon Oil & Energy Corporation, and “Diana (registered trademark) PROCESS OIL PW” series manufactured by Idemitsu Kosan Co., Ltd., and it is possible to appropriately select and use one among these.

[Component (E)]

The thermoplastic elastomer composition according to the present invention contains a crosslinking agent containing a phenol resin as Component (E).

The crosslinking agent as Component (E) partially crosslinks the above Component (B) in the thermoplastic elastomer composition during a dynamic heat treatment, thereby implementing a dynamic crosslinking type thermoplastic elastomer composition. Such a crosslinking agent can be appropriately selected from known ones, and examples thereof preferably include at least one selected from the group consisting of a phenol resin, an organic peroxide, a silicon hydride compound, a polyfunctional vinyl compound, a polyfunctional (meth)acrylate compound, and a tin chloride. More preferred are combinations of a phenol resin and a tin chloride, and an organic peroxide and a polyfunctional vinyl compound or a polyfunctional (meth)acrylate compound, and in the present invention, among these, a phenol resin is used as an essential component. Note that as the crosslinking agent, only one type of phenol resin may be used alone, or two or more types of other crosslinking agents may be used together with the phenol resin in any combination and ratio.

Examples of the phenol resin as Component (E) include an alkylphenol formaldehyde, which is a non-halogen phenol resin, and a bromated alkylphenol formaldehyde, which is a halogen phenol resin. One type of the phenol resin may be used alone, or two or more types thereof may be used in any combination.

As the phenol resin as Component (E), a non-halogen phenol resin is particularly preferred, and specifically those represented by the following formula (I) are preferred.

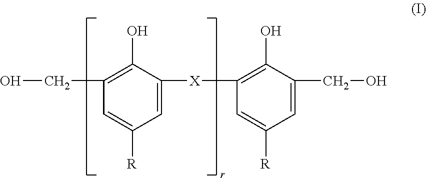

(In the formula, X is selected from —CH₂—, or —CH₂—O—CH₂—, which is a divalent linking group, r is an integer of 0 to 20, and R is an organic group having less than 20 carbon atoms, and preferably 1 to 12 carbon atoms.)

Examples of products of the above non-halogen phenol resin include Tackirol 201, 202 (product name) manufactured by Taoka Chemical Co., Ltd., PR-4507 (product name) manufactured by Gunei Chemical Industry Co., Ltd., Vulkaresat 510E, 532E, Vulkaresen E, 105E, 130E, and Vulkaresol 315E (product name) manufactured by Hoechst AG, Amberol ST 137X (product name) manufactured by Rohm & Haas Company, SUMILITE RESIN PR-22193 (product name) manufactured by Sumitomo Durez Co., Ltd., Symphorm-C-100, C-1001 (product name) manufactured by Anchor Chemicals Industries, TAMANOL 531 (product name) manufactured by Arakawa Chemical Industries, Ltd., Schenectady SP1045, SP1059 (product name) manufactured by Schenectady Chemicals, Inc., CRR-0803 (product name) manufactured by United Chemical Company, CRM-0803 (product name) manufactured by Showa Union Gosei Co., Ltd., and Vulkadur A (product name) manufactured by Bayer AG.

As the non-halogen phenol resin as Component (E), a p-octylphenol formaldehyde resin represented by the following formula (II) is particularly preferably used, and among them, one having a weight average molecular weight of 2,500 to 4,000 is most preferably used. As such a non-halogen phenol resin, those commercially available as the above Tackirol (registered trademark) 201, 202 can be used.

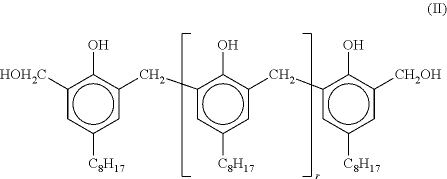

(In the formula, r is an integer of 0 to 20.)

Examples of the organic peroxide as Component (E) include an aromatic organic peroxide and an aliphatic organic peroxide. Specific examples thereof include but are not particularly limited to: dialkyl peroxides such as di-t-butyl peroxide, t-butylcumyl peroxide, dicumyl peroxide, 2,5-dimethyl-2,5-di(t-butylperoxy)hexane, 2,5-dimethyl-2,5-di(t-butylperoxy)-3-hexyne, 1,3-bis(t-butylperoxyisopropyl)benzene, and 1,1-di(t-butylperoxy)-3,3,5-trimethylcyclohexane; peroxyesters such as t-butyl peroxybenzoate, t-butylperoxyisopropyl carbonate, 2,5-dimethyl-2,5-di(benzoylperoxy)hexane, and 2,5-dimethyl-2,5-di(benzoylperoxy)-3-hexyne; and hydroperoxides such as acetyl peroxide, lauroyl peroxide, benzoyl peroxide, p-chlorobenzoyl peroxide, and 2,4-dichlorobenzoyl peroxide. Among these, 2,5-dimethyl-2,5-di(t-butylperoxy)hexane is preferred.

In addition to the above phenol resin and organic peroxide, other crosslinking agents may also be used. Examples thereof include: silicon hydride compounds such as methyl hydrogen silicon; auxiliary agents for peroxides such as sulfur, p-quinone dioxime, p-dinitrosobenzene, and 1,3-diphenylguanidine; polyfunctional vinyl compounds such as divinylbenzene, triallyl cyanurate, triallyl isocyanurate, and diallyl phthalate; polyfunctional (meth)acrylate compounds such as ethylene glycol di(meth)acrylate, diethylene glycol di(meth)acrylate, polyethylene glycol di(meth)acrylate, trimethylolpropane tri(meth)acrylate, and allyl(meth)acrylate; compounds having a bismaleimide structure such as N,N′-m-phenylenebismaleimide and N,N′-m-tolylenebismaleimide; trimethylolpropane; trimethylolpropane trimethacrylate; and a tin chloride (SnCl₂). Among these, divinylbenzene is preferred.

Note that one type of the crosslinking agent may be used alone, or two or more types thereof may be used in any combination and ratio. For example, it is preferable to use the above polyfunctional vinyl compound or polyfunctional (meth)acrylate compound together with the organic peroxide. In addition, the crosslinking agent containing a phenol resin is generally used together with an activator. As the activator that can be used here, for example, halogen donors such as stannous chloride, ferric chloride, chlorinated paraffins, chlorinated polyethylene, and chlorosulfonated polyethylene, and acid acceptors such as iron oxide, titanium oxide, magnesium oxide, silicon dioxide, and zinc oxide are used. When the phenol resin is halogenated, the halogen donor may not be used.

Note that commercially available crosslinking agents contain a hydrocarbon softener for rubber that corresponds to the above Component (D) and contain a filler. When the crosslinking agent used contains a hydrocarbon softener for rubber, the hydrocarbon softener for rubber shall be the hydrocarbon softener for rubber contained as Component (D). The same applies to the filler described below.

A phenol resin as Component (E), particularly a non-halogen phenol resin, is preferably used as Component (E) together with a tin chloride such as stannous chloride.

In this case, regarding a ratio of the phenol resin and the tin chloride as Component (E), it is preferable from the viewpoint of the activation effect of the phenol resin and good rubber elasticity that the tin chloride is from 10 to 100 parts by mass, and particularly from 20 to 50 parts by mass, based on 100 parts by mass of the phenol resin.

[Content]

In the thermoplastic elastomer composition according to the present invention, the content of Component (A) is preferably 1 mass % or more and less than 50 mass %, and more preferably is 3 mass % or more and 45 mass % or less, based on a total of 100 mass % of Component (A) and Component (B). The content of Component (A) is preferably equal to or greater than the above lower limit since the moldability and the high-temperature rubber elasticity are good. The content of Component (A) is preferably equal to or lower than the above upper limit since the flexibility is good.

The thermoplastic elastomer composition according to the present invention contains the P-Q type (hydrogenated) diblock copolymer in an amount of 0.05 to 2.0 mass % based on the total of 100 mass % of Components (A) to (E). Therefore, in the thermoplastic elastomer composition according to the present invention, the content of Component (C) may be set to such a content to satisfy this condition depending on the content of the P-Q type (hydrogenated) diblock copolymer.

Specifically, the content of Component (C) is preferably 0.1 part by mass or more based on the total of 100 parts by mass of Component (A) and Component (B). The content of Component (C) is preferably equal to or greater than the above lower limit since the surface smoothness is good. On the other hand, the content of Component (C) is preferably 400 parts by mass or less, more preferably 200 parts by mass or less, still more preferably 100 parts by mass or less, and particularly preferably 50 parts by mass or less, based on the total of 100 parts by mass of Component (A) and Component (B). The content of Component (C) is preferably equal to or lower than the above upper limit since the high-temperature rubber elasticity is good.

In the thermoplastic elastomer composition according to the present invention, Component (D) is preferably 50 parts by mass or more and 300 parts by mass or less, and more preferably 70 parts by mass or more and 250 parts by mass or less, based on a total of 100 parts by mass of Component (A) and Component (B). The content of Component (D) is preferably equal to or greater than the above lower limit since the moldability and the rubber elasticity are good. The content of Component (D) is preferably equal to or lower than the above upper limit since oil bleed resistance is good.

Note that the content of Component (D) here refers to, when the oil-extended ethylene-α-olefin-non-conjugated diene copolymer rubber is used as Component (B), a total content of the hydrocarbon softener for rubber in Component (B) and the hydrocarbon softener for rubber as Component (D), which is separately added in addition to Component (B), and, when a hydrocarbon softener for rubber is contained in Component (E), a total content including the hydrocarbon softener for rubber.

In the thermoplastic elastomer composition according to the present invention, Component (E) is preferably 0.5 parts by mass or more and 10 parts by mass or less based on the total of 100 parts by mass of Component (A) and Component (B). The content of Component (E) is preferably equal to or greater than the above lower limit since the rubber elasticity is good. The content of Component (E) is preferably equal to or lower than the above upper limit since the moldability is good.

From the similar viewpoint, in the thermoplastic elastomer composition according to the present invention, the phenol resin as Component (E) is preferably 1 part by mass or more and 10 parts by mass or less based on the total of 100 parts by mass of Component (A) and Component (B). The content of the phenol resin is preferably equal to or greater than the above lower limit since the rubber elasticity is good. The content of the phenol resin is preferably equal to or lower than the above upper limit since the moldability is good.

[Other Components]

In addition to Components (A) to (E), other components may be added to the thermoplastic elastomer composition according to the present invention, as necessary, within a range that does not impair the effects of the present invention.

Examples of the other components include resins such as a thermoplastic resin and an elastomer other than Components (A) to (C), and various additives such as an antioxidant, a filler, a heat stabilizer, a light stabilizer, an ultraviolet absorber, a neutralizing agent, a lubricant, an anti-fogging agent, an anti-blocking agent, a slip agent, a dispersant, a coloring agent, a flame retardant, an antistatic agent, a conductivity imparting agent, a metal deactivator, a molecular weight regulator, an antibacterial agent, an anti-mold material, and an optical brightener. Any of these can be used alone or in combination.

Examples of the thermoplastic resin other than Components (A) to (C) include: polyphenylene ether-based resins; polyamide-based resins such as nylon 6 and nylon 66; polyester-based resins such as polyethylene terephthalate and polybutylene terephthalate; polyoxymethylene-based resins such as a polyoxymethylene homopolymer and a polyoxymethylene copolymer; polymethyl methacrylate-based resins; and polyolefin resins (excluding those that fall under Component (A) or Component (B)). In addition, examples of the elastomer other than Components (A) to (C) include a polyester-based elastomer and a polybutadiene-based elastomer.

Examples of the antioxidant include a phenol-based antioxidant, a phosphite-based antioxidant, and a thioether-based antioxidant. In the case of using an antioxidant, it is generally used in a range of 0.01 to 3.0 parts by mass based on the total of 100 parts by mass of Component (A) and Component (B).

Examples of the filler include a glass fiber, a hollow glass bulb, a carbon fiber, talc, calcium carbonate, clay, mica, a potassium titanate fiber, silica, metal soap, titanium dioxide, and carbon black. In the case of using a filler, it is generally used in an amount of 0.1 to 50 parts by mass based on the total of 100 parts by mass of Component (A) and Component (B).

Examples of the lubricant include a fatty acid amide, a fatty acid metal salt, and an organopolysiloxane. In the case of using a lubricant, it is generally used in a range of 0.01 to 5.0 parts by mass based on the total of 100 parts by mass of Component (A) and Component (B).

[Method for Producing Thermoplastic Elastomer Composition]

The thermoplastic elastomer composition according to the present invention is produced by subjecting dynamic heat treatment in the presence of a composition containing a predetermined amount of Component (A), Component (B), Component (C), and Component (D) and other components used as necessary as described above, and preferably in the presence of a crosslinking agent containing a phenol resin as Component (E).

In the present invention, the “dynamic heat treatment” means kneading in a molten or semi-molten state in the presence of a crosslinking agent. The dynamic heat treatment is preferably carried out by melt-kneading, and examples of a melt-kneading apparatus used for this purpose include a closed Banbury mixer, a mixing roll, a kneader, and a twin-screw extruder. Among these, a twin-screw extruder is preferably used. A preferred form of the production method using this twin-screw extruder is one in which a dynamic heat treatment is carried out by supplying each component to a raw material supply port (hopper) of the twin-screw extruder having a plurality of raw material supply ports.

A temperature during the dynamic heat treatment is generally from 80° C. to 300° C., and preferably from 100° C. to 250° C. In addition, the time for carrying out the dynamic heat treatment is generally from 0.1 to 30 minutes.

When the thermoplastic elastomer composition according to the present invention is produced by a dynamic heat treatment using a twin-screw extruder, it is preferable to perform extrusion while maintaining a relationship expressed by the following formula (i) among a barrel radius (R (mm)), a screw rotation speed (N (rpm)), and a discharge amount (Q (kg/h)) of the twin-screw extruder, and it is more preferable to perform extrusion while maintaining the relationship expressed by the following formula (ii).

2.6<NQ/R³<22.6 (i)

3.0<NQ/R³<20.0 (ii)

It is preferable that the above relationship among the barrel radius (R (mm)), the screw rotation speed (N (rpm)), and the discharge amount (Q (kg/h)) of the twin-screw extruder is greater than the above lower limit value in order to efficiently produce a thermoplastic elastomer composition. On the other hand, it is preferable that the above relationship is less than the above upper limit value in order to prevent heat generation due to shearing and to prevent generation of foreign substances which cause a poor appearance.

Note that when producing the thermoplastic elastomer composition according to the present invention, the ethylene-α-olefin-non-conjugated diene copolymer rubber as Component (B) can be treated with at least a portion of the hydrocarbon softener for rubber as Component (D), and Component (B) can also be used as an oil-extended ethylene-α-olefin-non-conjugated diene copolymer rubber.

As a method (oil extension method) for producing the oil-extended ethylene-α-olefin-non-conjugated diene copolymer rubber using Component (B) and Component (D), a method similar to the method for preparing the oil-extended ethylene-α-olefin-non-conjugated diene copolymer rubber described above can be used.

[Physical Properties of Thermoplastic Elastomer Composition]

Regarding a molded article obtained by molding the thermoplastic elastomer composition according to the present invention, durometer hardness A (value after 15 seconds) measured in accordance with JIS K6253 (2006 edition) (Duro-A) is preferably 95 or less, more preferably 90 or less, and particularly preferably 85 or less, since the high-temperature rubber elasticity tends to be easily controlled to be good. On the other hand, the durometer hardness A is preferably 20 or more, more preferably 25 or more, and particularly preferably 45 or more since the surface smoothness tends to be easily controlled to be good.

From the viewpoint of achieving both the high-temperature rubber elasticity and the surface smoothness, the durometer hardness A (value after 15 seconds) is preferably 45 to 90, and 45 to 85.

[Molded Article and Application]

The thermoplastic elastomer composition according to the present invention can be made into a molded article by methods generally used for a thermoplastic elastomer composition, for example, various molding methods such as injection molding, extrusion molding, blow molding, and compression molding. Among these, injection molding and extrusion molding are suitable. In addition, after performing these moldings, a molded article can be obtained by performing secondary processing such as lamination molding or thermoforming.

The thermoplastic elastomer composition according to the present invention has excellent surface smoothness and high-temperature rubber elasticity and can be used in wide variety of fields such as automobile field (seals, cushions, boots, etc.), architecture field (gaskets, packing, etc.), various other miscellaneous goods fields, sporting goods (grips for golf clubs and tennis rackets, etc.), industrial parts (hose tubes, gaskets, etc.), home appliance parts (hoses, packing, etc.), medical parts (medical containers, gaskets, packing, etc.), food parts (containers, packing, etc.), medical equipment parts, electric wire covering materials, and other miscellaneous goods. Among these, it is suitable to use the molded article made of the thermoplastic elastomer composition according to the present invention for automobile seals which require a good appearance, and various sealing materials, boots, packing, and gaskets which require sealability.

### EXAMPLES

Hereinafter, the present invention will be described in more detail using Examples, but the present invention is not limited to the following Examples unless it departs from the gist thereof. The values of the various production conditions and evaluation results in the following Examples mean preferred values of the upper limit or the lower limit in embodiments of the present invention, and a preferred range may be a range defined by the aforementioned upper limit or lower limit value and either the value in the Example or a combination of the values in the Examples.

[Raw Materials]

The raw materials used in the following Examples and Comparative Examples are as follows.

[Component (A)]
(A-1): propylene homopolymer, Novatec (registered trademark) PP FY6 manufactured by Japan Polypropylene Corporation
Propylene unit content: 100 mass %
MFR (230° C., 21.18 N): 2.5 g/10 min
Weight average molecular weight: 520,000
(A-2): propylene homopolymer, Novatec (registered trademark) PP MA3 manufactured by Japan Polypropylene Corporation
Propylene unit content: 100 mass %
MFR (230° C., 21.18 N): 11 g/10 min
Weight average molecular weight: 360,000

[Component (B)]
(B-1)+(D) mixture: oil-extended ethylene-propylene-5-ethylidene-2-norbornene copolymer rubber (mixture of 100 parts by mass of Component (B-1) and 40 parts by mass of Component (D)), 3072EPM manufactured by Mitsui Chemicals, Inc.
Mooney viscosity ML₁₊₄ (125° C.): 51
(B-1): ethylene-propylene-5-ethylidene-2-norbornene copolymer
Mooney viscosity ML₁₊₄ (125° C.): 94
Ethylene unit content: 64 mass %
5-Ethylidene-2-norbornene unit content: 5.4 mass %
Density: 0.88 g/cm³
Polymerization catalyst: metallocene catalyst
(B-2)+(D-1) mixture: oil-extended ethylene-propylene-5-ethylidene-2-norbornene copolymer rubber (mixture of 100 parts by mass of Component (B-2) and 100 parts by mass of Component (D-1))
Mooney viscosity ML₁₊₄ (125° C.): 64
Density: 0.86 g/cm³
(B-2): ethylene-propylene-5-ethylidene-2-norbornene copolymer
Mooney viscosity ML₁₊₄ (125° C.): 293
Ethylene unit content: 67 mass %
5-Ethylidene-2-norbornene unit content: 4.5 mass %
Polymerization catalyst: Ziegler-Natta catalyst
(D-1): paraffin-based oil, Diana (registered trademark) PROCESS OIL PW-90 manufactured by Idemitsu Kosan Co., Ltd.
Kinematic viscosity at 40° C.: 95.54 cSt
Pour point: −15° C.
Flash point: 272° C.

[Component (C)]
(C-1): hydrogenated block copolymer of aromatic vinyl compound and conjugated diene compound, KRATON G1657 manufactured by KRATON CORPORATION
Styrene block P content: 13 mass %
Number average molecular weight: 76,500
P-Q type hydrogenated diblock copolymer content: 29 mass %
(C-1′): hydrogenated block copolymer of aromatic vinyl compound and conjugated diene compound, KRATON G1651 manufactured by KRATON CORPORATION
Styrene block P content: 33 mass %
Number average molecular weight: 220,000
P-Q type hydrogenated diblock copolymer content: less than 1 mass %

[Component (D)]
(D-1): paraffin-based oil, Diana (registered trademark) PROCESS OIL PW-90 manufactured by Idemitsu Kosan Co., Ltd.
Kinematic viscosity at 40° C.: 95.54 cSt
Pour point: −15° C.
Flash point: 272° C.
(D-2): paraffin-based oil, Diana (registered trademark) PROCESS OIL PW-32 manufactured by Idemitsu Kosan Co., Ltd.
Kinematic viscosity at 40° C.: 30.60 cSt
Pour point: −17.5° C.
Flash point: 222° C.

[Component (E)]
(E-1)+(D-2) mixture: phenol resin (mixture of 30 parts by mass of Component (E-1) and 70 parts by mass of Component (D-2)
(E-1): alkylphenol formaldehyde resin with methylol groups at both ends, Tackirol (registered trademark) 201 manufactured by Taoka Chemical Co., Ltd.
(D-2): paraffin-based oil, Diana (registered trademark) PROCESS OIL PW-32 manufactured by Idemitsu Kosan Co., Ltd.
Kinematic viscosity at 40° C.: 30.60 cSt
Pour point: −17.5° C.
Flash point: 222° C.
(E-2): stannous chloride, manufactured by FUJIFILM Wako Pure Chemical Corporation

[Component (F)]
(F-1): filler, Talc PHSH manufactured by Takehara Chemical Industrial Co., Ltd.

[Component (G)]
(G-1): antioxidant, Irganox (registered trademark) 1076 manufactured by BASF Japan Ltd.

[Component (H)]
(H-1): acid acceptor, zinc oxide manufactured by FUJIFILM Wako Pure Chemical Corporation

[Evaluation Method]

Evaluation method for thermoplastic elastomer compositions in the following Examples and Comparative Examples are as follows.

Note that in measurement of the following (1) to (3), each of the thermoplastic elastomer compositions was used, and each of the thermoplastic elastomer compositions was subjected to injection molding with an injection molding machine of an in-line screw type (“IS130” manufactured by Toshiba Machine Co., Ltd.) under conditions at an injection pressure of 50 MPa, a cylinder temperature of 220° C., and a mold temperature of 40° C., thereby obtaining a sheet of 2 mm in thickness, 120 mm in width, and 120 mm in length.

In the compression set measurement in (2), a test piece was prepared by stacking six Type A disks (29 mmφ) each obtained by punching out the obtained sheet (thickness 2 mm×width 120 mm×length 120 mm), and the measurement was made in accordance with JIS K6262 using this test piece.

In the peel strength measurement in (3), Kraft tape No. 204 manufactured by Okamoto Industries, Inc. was cut to a length of 120 mm, 20 mm of an adhesive surface of the tape was stuck onto the obtained sheet (thickness 2 mm×width 120 mm×length 120 mm), the remaining 100 mm of the adhesive surface of the tape was stuck together to form a gripping part, followed by cutting to a width of 15 mm to prepare a test piece, and the measurement was carried out using this test piece.

In addition, in surface roughness measurement in (4), molding was performed using a 40 mm diameter single-screw extruder (L/D=28, compression ratio=2.0, full flight screw) manufactured by IKG Corporation, using a sheet-shaped die having a width of 25 mm and a thickness of 1 mm, under conditions of a molding temperature at the hopper bottom of 170° C., at the cylinder of 180° C. to 200° C., and at the die of 200° C., and a screw rotation speed of 30 rpm, and the measurement was carried out using the obtained sheet.

(1) Durometer Hardness A

Hardness (after 15 seconds) was measured with reference to JIS K6253 (Duro-A).

(2) Compression Set

The measurement was performed with reference to JIS K6262 at 70° C. for 22 hours under a compression condition of 25%.

(3) Peel Strength

Peel strength was measured under conditions of a peel angle of 180 degrees and a peel rate of 100 mm/min. It was determined that the greater the peel strength, the better the surface smoothness.

(4) Surface Roughness

Root-mean-square surface roughness was measured with reference to the JIS B0601 (2001) standard. It was determined that the smaller the value of surface roughness, the better the surface smoothness.

In Examples 1 to 5 and Comparative Examples 1 to 6, the surface smoothness was evaluated based on the surface roughness in (4).

In Examples 6 to 8 and Comparative Examples 7 to 16, the surface smoothness was evaluated based on the peel strength in (3).

### EXAMPLES/COMPARATIVE EXAMPLES

### Example 1

In a Henschel mixer, 42 parts by mass of Component (A-1), 81 parts by mass of Component (B-1)+(D) mixture (breakdown Component (B-1): 58 parts by mass, (D): 23 parts by mass), 2 parts by mass of Component (C-1), 0.8 parts by mass of Component (E-2), 7 parts by mass of Component (F-1), 0.2 parts by mass of Component (G), and 0.4 parts by mass of Component (H) were blended for 1 minute. The mixture was charged into an upstream supply port of a co-directional twin-screw extruder (“TEX30” from Japan Steel Works, L/D=52.5, number of cylinder blocks: 14) using a gravimetric feeder. As the remaining components, 8.5 parts by mass of Component (E-1)+(D-2) mixture (breakdown Component (E-1): 2.5 parts by mass, (D-2): 6 parts by mass)) and 43 parts by mass of (D-1), were each supplied from a supply port in the middle of the extruder using a liquid addition pump, the temperature was increased from an upstream part to a downstream part in a range of 140° C. to 200° C. at a total discharge amount of 25 kg/h, and the mixture was melt-kneaded and pelletized to produce a thermoplastic elastomer composition. The obtained thermoplastic elastomer composition was evaluated as described in (1), (2), and (4) above. The evaluation results obtained are shown in Table 1.

### Examples 2 to 4 and Comparative Examples 1 to 3

Pellets of a thermoplastic elastomer composition were obtained in the same manner as in Example 1, except that the compositions of Components (A) to (E) (in Comparative Example 3, Component (C′) instead of Component (C)) were changed as shown in Table 1. The evaluation similar to that in Example 1 was performed using the obtained thermoplastic elastomer composition. The evaluation results obtained are shown in Table 1.

In Table 1, the content of the P-Q type hydrogenated diblock copolymer based on a total of 100 mass % of Components (A), (B), (C), (D), and (E) (a total of Components (A), (B), (C′), (D), and (E) in Comparative Example 3) is simply described as “content of P-Q type hydrogenated diblock copolymer”. The same applies to Table 2 to Table 5 below.

TABLE 1

| | | | | | | | Com- | Com- | Com- |
|---|---|---|---|---|---|---|---|---|---|
| | | | | | | | parative | parative | parative |
| | | | Ex- | Ex- | Ex- | Ex- | Ex- | Ex- | Ex- |
| | | | ample | ample | ample | ample | ample | ample | ample |
| | | | 1 | 2 | 3 | 4 | 1 | 2 | 3 |
| Com- | Component | Part | 42 | 42 | 42 | | 42 | 42 | 42 |
| position | (A-1) | by | | | | | | | |
| | | mass | | | | | | | |
| | Component | Part | | | | 42 | | | |
| | (A-2) | by | | | | | | | |
| | | mass | | | | | | | |
| | Component | Part | 58 | 58 | 58 | 58 | 58 | 58 | 58 |
| | (B-1) | by | | | | | | | |
| | | mass | | | | | | | |
| | Component | Part | 2 | 7 | 12 | 7 | | 17 | |
| | (C-1) | by | | | | | | | |
| | | mass | | | | | | | |
| | Component | Part | | | | | | | 7 |
| | (C′-1) | by | | | | | | | |
| | | mass | | | | | | | |
| | Component | Part | 72 | 72 | 72 | 72 | 72 | 72 | 72 |
| | (D)* | by | | | | | | | |
| | | mass | | | | | | | |
| | Component | Part | 2.5 | 2.5 | 2.5 | 2.5 | 2.5 | 2.5 | 2.5 |
| | (E-1) | by | | | | | | | |
| | | mass | | | | | | | |
| Content of P-Q type | | mass | 0.3 | 1.1 | 1.8 | 1.1 | 0.0 | 2.6 | <0.04 |
| hydrogenated | | % | | | | | | | |
| diblock copolymer | | | | | | | | | |
| Eval- | Durometer | — | 76 | 75 | 74 | 75 | 76 | 74 | 77 |
| uation | hardness A | | | | | | | | |
| result | Com- | % | 35 | 38 | 40 | 40 | 36 | 45 | 37 |
| | pression set | | | | | | | | |
| | (70° C. × | | | | | | | | |
| | 22 hours) | | | | | | | | |
| | Surface | μm | 3.8 | 3.8 | 3.3 | 2.2 | 4.2 | 3.3 | 4.8 |
| | roughness | | | | | | | | |

*Total of Component (D) in (B-1) + (D) mixture, the separately added Component (D-1), and Component (D-2) in (E-1) + (D-2) mixture for use in thermoplastic elastomer composition

### Example 5 and Comparative Examples 4 to 6

Pellets of a thermoplastic elastomer composition were obtained in the same manner as in Example 1, except that the compositions of Components (A) to (E) (in Comparative Example 6, Component (C′) instead of Component (C)) were changed as shown in Table 2. The evaluation similar to that in Example 1 was performed using the obtained thermoplastic elastomer composition. The evaluation results obtained are shown in Table 2.

TABLE 2

| | | | | Com- | Com- | Com- |
|---|---|---|---|---|---|---|
| | | | | parative | parative | parative |
| | | | Ex- | Ex- | Ex- | Ex- |
| | | | ample | ample | ample | ample |
| | | | 5 | 4 | 5 | 6 |
| Com- | Component | Part by | 38 | 38 | 38 | 38 |
| position | (A-1) | mass | | | | |
| | Component | Part by | 62 | 62 | 62 | 62 |
| | (B-1) | mass | | | | |
| | Component | Part by | 8 | | 19 | |
| | (C-1) | mass | | | | |
| | Component | Part by | | | | 8 |
| | (C′-1) | mass | | | | |
| | Component | Part by | 96 | 96 | 96 | 96 |
| | (D)* | mass | | | | |
| | Component | Part by | 2.5 | 2.5 | 2.5 | 2.5 |
| | (E-1) | mass | | | | |
| Content of P-Q type | | mass | 1.1 | 0.0 | 2.6 | <0.04 |
| hydrogenated | | % | | | | |
| diblock copolymer | | | | | | |
| Eval- | Durometer | — | 65 | 67 | 64 | 67 |
| uation | hardness A | | | | | |
| result | Com- | % | 34 | 33 | 39 | 31 |
| | pression set | | | | | |
| | (70° C. × | | | | | |
| | 22 hours) | | | | | |
| | Surface | μm | 5.3 | 5.8 | 5.0 | 6.9 |
| | roughness | | | | | |

*Total of Component (D) in (B-1) + (D) mixture, the separately added Component (D-1), and Component (D-2) in (E-1) + (D-2) mixture for use in thermoplastic elastomer composition

### Example 6 and Comparative Examples 7 to 9

Pellets of a thermoplastic elastomer composition were obtained in the same manner as in Example 1, except that the (B-2)+(D-1) mixture was used instead of the (B-1)+(D) mixture as shown in Table 3. The evaluations in (1) to (3) above were performed using the obtained thermoplastic elastomer composition. The evaluation results obtained are shown in Table 3.

TABLE 3

| | | | | Com- | Com- | Com- |
|---|---|---|---|---|---|---|
| | | | | parative | parative | parative |
| | | | Ex- | Ex- | Ex- | Ex- |
| | | | ample | ample | ample | ample |
| | | | 6 | 7 | 8 | 9 |
| Com- | Component | Part by | 42 | 42 | 42 | 42 |
| position | (A-1) | mass | | | | |
| | Component | Part by | 58 | 58 | 58 | 58 |
| | (B-1) | mass | | | | |
| | Component | Part by | 7 | | 17 | |
| | (C-1) | mass | | | | |
| | Component | Part by | | | | 7 |
| | (C′-1) | mass | | | | |
| | Component | Part by | 72 | 72 | 72 | 72 |
| | (D)* | mass | | | | |
| | Component | Part by | 2.5 | 2.5 | 2.5 | 2.5 |
| | (E-1) | mass | | | | |
| Content of P-Q type | | mass | 1.1 | 0.0 | 2.6 | <0.04 |
| hydrogenated | | % | | | | |
| diblock copolymer | | | | | | |
| Eval- | Durometer | — | 80 | 81 | 79 | 81 |
| uation | hardness A | | | | | |
| result | Com- | % | 45 | 41 | 49 | 41 |
| | pression set | | | | | |
| | (70° C. × | | | | | |
| | 22 hours) | | | | | |
| | Peel | N/15 | 2.0 | 1.3 | 2.4 | 1.4 |
| | strength | mm | | | | |

*Total of Component (D-1) in (B-2) + (D-1) mixture, the separately added Component (D-1), and Component (D-2) in (E-1) + (D-2) mixture for use in thermoplastic elastomer composition

### Example 7 and Comparative Examples 10 to 12

Pellets of a thermoplastic elastomer composition were obtained in the same manner as in Example 1, except that the (B-2)+(D-1) mixture was used instead of the (B-1)+(D) mixture as shown in Table 4. The evaluations in (1) to (3) above were performed using the obtained thermoplastic elastomer composition. The evaluation results obtained are shown in Table 4.

TABLE 4

| | | | | Com- | Com- | Com- |
|---|---|---|---|---|---|---|
| | | | | parative | parative | parative |
| | | | Ex- | Ex- | Ex- | Ex- |
| | | | ample | ample | ample | ample |
| | | | 7 | 10 | 11 | 12 |
| Com- | Component | Part by | 38 | 38 | 38 | 38 |
| position | (A-1) | mass | | | | |
| | Component | Part by | | | | |
| | (B-2) | mass | | | | |
| | Component | Part by | | | | |
| | (C-1) | mass | | | | |
| | Component | Part by | | | | |
| | (C′-1) | mass | 62 | 62 | 62 | 62 |
| | Component | Part by | 8 | | 19 | |
| | (D)* | mass | | | | 8 |
| | Component | Part by | 96 | 96 | 96 | 96 |
| | (E-1) | mass | 2.5 | 2.5 | 2.5 | 2.5 |
| Content of P-Q type | | mass | 1.1 | 0.0 | 2.6 | <0.04 |
| hydrogenated | | % | | | | |
| diblock copolymer | | | | | | |
| Eval- | Durometer | — | 70 | 72 | 69 | 72 |
| uation | hardness A | | | | | |
| result | Com- | % | 41 | 37 | 47 | 37 |
| | pression set | | | | | |
| | (70° C. × | | | | | |
| | 22 hours) | | | | | |
| | Peel | N/15 | 1.4 | 0.9 | 1.8 | 1.1 |
| | strength | mm | | | | |

*Total of Component (D-1) in (B-2) + (D-1) mixture, the separately added Component (D-1), and Component (D-2) in (E-1) + (D-2) mixture for use in thermoplastic elastomer composition

### Examples 8 and 9 and Comparative Examples 13 and 14

Pellets of a thermoplastic elastomer composition were obtained in the same manner as in Example 1, except that the (B-2)+(D-1) mixture was used instead of the (B-1)+(D) mixture as shown in Table 5. The evaluations in (1) to (3) above were performed using the obtained thermoplastic elastomer composition. The evaluation results obtained are shown in Table 5.

TABLE 5

| | | | | | Com- | Com- |
|---|---|---|---|---|---|---|
| | | | | | parative | parative |
| | | | Ex- | Ex- | Ex- | Ex- |
| | | | ample | ample | ample | ample |
| | | | 8 | 9 | 13 | 14 |
| Com- | Component | Part by | 28 | 24 | 28 | 24 |
| position | (A-1) | mass | | | | |
| | Component | Part by | 72 | 76 | 72 | 76 |
| | (B-2) | mass | | | | |
| | Component | Part by | 9 | 10 | | |
| | (C-1) | mass | | | | |
| | Component | Part by | 124 | 144 | 124 | 144 |
| | (D)* | mass | | | | |
| | Component | Part by | 2.5 | 2.5 | 2.5 | 2.5 |
| | (E-1) | mass | | | | |
| Content of P-Q type | | mass | 1.1 | 1.1 | 0.0 | 0.0 |
| hydrogenated | | % | | | | |
| diblock copolymer | | | | | | |
| Eval- | Durometer | — | 54 | 47 | 55 | 49 |
| uation | hardness A | | | | | |
| result | Com- | % | 28 | 27 | 28 | 25 |
| | pression set | | | | | |
| | (70° C. × | | | | | |
| | 22 hours) | | | | | |
| | Peel | N/15 | 0.7 | 0.6 | 0.4 | 0.2 |
| | strength | mm | | | | |

*Total of Component (D-1) in (B-2) + (D-1) mixture, the separately added Component (D-1), and Component (D-2) in (E-1) + (D-2) mixture for use in thermoplastic elastomer composition

[Evaluation Results]

As seen from Table 1 to Table 5, Examples 1 to 9, which correspond to the thermoplastic elastomer composition according to the present invention containing a P-Q type (hydrogenated) diblock copolymer in a predetermined proportion, have a good compression set (high-temperature rubber elasticity) and surface smoothness.

On the other hand, Comparative Examples 1, 4, 7, 10, 13, and 14 are examples that do not contain a P-Q type (hydrogenated) diblock copolymer. Comparative Examples 1 and 4 have poor surface roughness and Comparative Examples 7, 10, 13, and 14 have poor peel strength as compared to Examples, which have poor surface smoothness. Comparative Examples 2, 5, 8, and 11 are examples in which the content of the P-Q type (hydrogenated) diblock copolymer is 2.6 mass %, but the compression set is large and the high-temperature rubber elasticity is poor. Comparative Examples 3, 6, 9, and 12 are examples in which Component (C′-1) is used instead of Component (C-1) in Examples and the P-Q type (hydrogenated) diblock copolymer is contained in an amount less than 0.04 mass %. Comparative Examples 3 and 6 have poor surface roughness and Comparative Examples 9 and 12 have poor peel strength as compared to Examples, which have poor surface smoothness. A P-Q-P type (hydrogenated) triblock copolymer which is a component other than the P-Q type (hydrogenated) diblock copolymer contained in Component (C) also forms an aggregate on the surface of the molded article. It is presumed that since a small content of the P-Q type (hydrogenated) diblock copolymer is contained in Comparative Examples 3, 6, 9, and 12, the surface smoothness deteriorates because the proportion of the polymer block Q of the P-Q type (hydrogenated) diblock copolymer precipitated on the surface is smaller than that in Examples.

While the present invention has been described in detail and with reference to specific embodiments thereof, it will be apparent to one skilled in the art that various changes and modifications can be made therein without departing from the spirit and scope of the present invention. The present application is based on a Japanese patent application filed on Jun. 30, 2021 (Japanese Patent Application No. 2021-108343), the entireties of which are incorporated by reference.

### INDUSTRIAL APPLICABILITY

The thermoplastic elastomer composition according to the present invention has excellent high-temperature rubber elasticity and surface smoothness. The thermoplastic elastomer composition according to the present invention has good high-temperature rubber elasticity and surface smoothness, and is thus useful for automobile parts, architectural parts, medical parts, electric wire covering materials, miscellaneous goods, and the like, specifically, automobile seals that require a good appearance, and various sealing materials, boots, packing, and gaskets which require sealability.

1. A thermoplastic elastomer composition comprising Components (A) to (E), wherein a P-Q type diblock copolymer and/or a hydrogenated product thereof is contained in an amount of 0.05 to 2.0 mass % based on a total of 100 mass % of Components (A) to (E):
Component (A): a polyolefin;
Component (B): an ethylene-α-olefin-non-conjugated diene copolymer rubber;
Component (C): a block copolymer and/or a hydrogenated product thereof including a polymer block P mainly containing an aromatic vinyl compound unit and a polymer block Q mainly containing a conjugated diene unit and including the P-Q type diblock copolymer containing one polymer block P and one polymer block Q;
Component (D): a hydrocarbon softener for rubber; and
Component (E): a crosslinking agent containing a phenol resin.

2. The thermoplastic elastomer composition according to claim 1, comprising Component (D) in an amount of 50 parts by mass or more and 300 parts by mass or less based on a total of 100 parts by mass of Component (A) and Component (B).

3. The thermoplastic elastomer composition according to claim 1, wherein durometer hardness A in JIS K6253 (2006 edition) is 95 or less.

4. The thermoplastic elastomer composition according to claim 3, wherein the durometer hardness A in JIS K6253 (2006 edition) is 90 or less.

5. The thermoplastic elastomer composition according to claim 1, wherein durometer hardness A in JIS K6253 (2006 edition) is 45 or more and 95 or less.

6. The thermoplastic elastomer composition according to claim 5, wherein the durometer hardness A in JIS K6253 (2006 edition) is 45 or more and 85 or less.

7. The thermoplastic elastomer composition according to claim 1, wherein Component (C) is the block copolymer and/or the hydrogenated product thereof comprising 1 mass % or more and 100 mass % or less of the P-Q type diblock copolymer.

8. The thermoplastic elastomer composition according to claim 1, wherein a content of Component (A) is 1 mass % or more and less than 50 mass % based on a total of 100 mass % of Component (A) and Component (B).

9. The thermoplastic elastomer composition according to claim 1, comprising Component (C) in an amount of 0.1 parts by mass or more and 400 parts by mass or less based on a total of 100 parts by mass of Component (A) and Component (B).

10. The thermoplastic elastomer composition according to claim 1, wherein Component (E) contains a phenol resin and a tin chloride.

11. The thermoplastic elastomer composition according to claim 1, wherein a weight average molecular weight of Component (A) measured by gel permeation chromatography calibrated with polystyrene standards is 270,000 or more and 1,000,000 or less.

12. A molded article obtained by molding the thermoplastic elastomer composition according to claim 1.
